(19) United States
(12) Patent Application Publication
(10) Pub. No.: US 2009/0035050 A1
(43) Pub. Date: Feb. 5, 2009

(54) Self-balancing magnetic objects

(76) Inventor: Alex Soriano Ramos, Alpharetta, GA (US)

Correspondence Address: JAMES RAY & ASSOCIATES, 2640 PITCAIRN ROAD, MONROEVILLE, PA, 15146, US

(21) Appl. No.: 12/221,106

(22) Filed: Aug. 28, 2008

Related U.S. Application Data
(60) Provisional application No. 60/953,026, filed on Jul. 31, 2007.

(51) Int. Cl. B43K 23/04; A47G 29/00

(52) U.S. Cl. 401/131; 248/346.03

(57) ABSTRACT

A magnetically self balancing pen and base includes a base member housing a disk magnet and a concentric ring magnet having a predetermined inside diameter. The pen assembly has a barrel, an elongated ink cartridge with a magnetically attractable tip, and an annular magnet disposed inside the barrel and around the elongated ink cartridge. The annular magnet is located proximal but separated from the magnetically attractable tip with the end proximal the tip having a polarity equal to that of an upper surface of the ring magnet in the base.

### CROSS REFERENCE TO RELATED APPLICATION

This patent application is related to and claims priority from U.S. Provisional Patent Application Ser. No. 60/953,026 filed Jul. 31, 2007.

### FIELD OF THE INVENTION

The present invention relates, in general, to novelty desk items and, more particularly, this invention relates to an apparatus that appears to make pens and other useful objects appear to be standing in defiance of gravity.

### BACKGROUND OF THE INVENTION

Prior to the conception and development of the present invention, office occupants frequently display an eye-catching object or conversation piece on their desk. These may be related to sports or hobbies, but are typically not of much utility. Pens are useful common desk items, so incorporating one into a novelty yet removable-for-use display item serves a dual purpose.

Some magnetically enhanced pen displays have been disclosed in the prior art. Spatz in U.S. Pat. No. 2,693,788 disclosed a magnetic desk pen set wherein the top tip of the pen is engaged in a recess in one end of a base. The other end of the base has magnets arranged to repel a magnetic element inside the pen such that the writing end of the pen is levitating within a cradle of the base. Thus, the pen is substantially in a prone position with the writing tip pointed slightly upward.

In U.S. Pat. No. 4,643,604, Enrico discloses a magnetic pen holder wherein a permanent magnet is positioned within the pen a short distance from the tip. The pen is then lodged within a cavity in a base member which has magnets oriented to attract the magnet housed in the pen. In this Enrico patent, the pen can only be positioned straight up, and because of the cavity, it appears to be very similar to a holder where the pen is held just by friction. The same two drawbacks apply to the magnetic pen holder shown in U.S. Design Pat. No. D510,954.

Although not magnetic, Bergstrom in U.S. Pat. No. discloses a pen that provides the illusion of standing straight up on its own by use of weight near the writing tip. Out of necessity, the pen point must be retractable, and the writing end is rather large and clumsy to hold.

### SUMMARY OF THE INVENTION

The present invention provides a magnetically self balancing pen and base including a substantially flat-resting base member housing a disk magnet and a concentric ring magnet having a predetermined inside diameter and strength. The pen assembly has a barrel, an elongated ink cartridge with a magnetically attractable tip, and an annular magnet disposed inside the barrel and around the elongated ink cartridge. The annular magnet is located proximal but separated from the magnetically attractable tip with the end proximal the tip having a polarity equal to that of an upper surface of the ring magnet in the base.

In a preferred alternative embodiment, the two base magnets are imbedded concentrically within a common desk item such as a mousepad, notepad, or book, and the special pen is suspended above. In a second alternative embodiment, items such as a business card holder are removable balanced with like magnet arrangements. In another alternative embodiment, the magnetic arrangement is inverted and the two concentric magnets are imbedded in a useful reusable item such as a salt shaker. A separate flat-bottom base holds the rod with a magnetically attractable tip.

### OBJECTS OF THE INVENTION

It is, therefore, one of the primary objects of the present invention to provide a writing pen that appears to be magically standing upright.

Another object of the present invention is to provide a manner for displaying items in apparent defiance of gravity while still being readily removable for use.

Still another object of the present invention is to provide a novelty yet useful pen that can also write on paper without the pen being touched or held.

Yet another object of the present invention is to provide various common items, such as salt shakers or business card holders, removably supported in a novelty manner.

An additional object of the present invention is to provide a pen and base combination wherein the pen appears to be magically balanced about a surface in a slanted position.

In addition to the various objects and advantages of the present invention described with some degree of specificity above, it should be obvious that additional objects and advantages of the present invention will become more readily apparent to those persons who are skilled in the relevant art from the following more detailed description of the invention, particularly, when such description is taken in conjunction with the attached drawing figures and with the appended claims.

### BRIEF DESCRIPTION OF THE DRAWINGS

FIG. 1 is an elevation perspective view of the most preferred embodiment of the present invention.

FIG. 2 is an elevation cross section view of a preferred embodiment of the present invention.

FIG. 3 is an exploded perspective view of the underside of the base member.

FIG. 4 provides a perspective view of a use of the present invention.

FIG. 5 is a perspective view of an alternative embodiment of the present invention.

FIG. 6 presents a perspective view of a second alternative embodiment of the present invention.

FIG. 7 provides perspective views of three examples of the present invention embedded into common desk items.

FIG. 8 provides an exploded perspective view of an alternative arrangement of the base magnets.

FIG. 9 is a perspective view of another alternative magnetic ring arrangement in use.

### DETAILED DESCRIPTION OF A PRESENTLY PREFERRED AND VARIOUS ALTERNATIVE EMBODIMENTS OF THE INVENTION

Prior to proceeding to the more detailed description of the present invention it should be noted that, for the sake of clarity and understanding, identical components which have identical functions have been identified with identical reference numerals throughout the several views illustrated in the drawing figures.

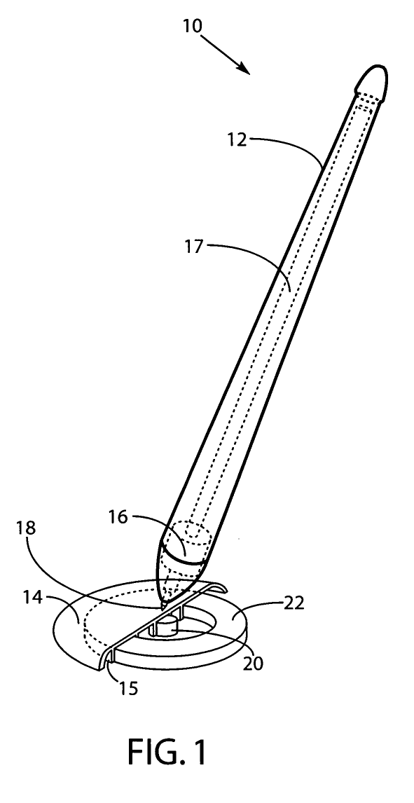

Referring initially to FIG. 1, the present invention in the most preferred embodiment is illustrated, generally as 10. A special writing pen 12 has an interior annular magnet 16 proximal a ferromagnetic tip 18 and surrounding the ink barrel 17. The annular magnet 16 can be one individual magnet or a stack of multiple magnets, in either case preferably axially magnetized neodymium (NdFeB) type. A separate base 14 contains a central disk magnet 20 and a ring magnet 22. One example of an acceptable ring magnet 22 would be a standard model RX4C2 from K & J Magnetics. Preferably, the polarity of the top surface of the disk magnet 20 is opposite that of the end of the annular magnet 16 closest to the tip 18. The polarity of the lower end of the annular magnet 16 must be the same as that of the top face of the ring magnet 22. An underside member 15 in the base 14 aids in retaining and positioning the magnets 20 and 22, which can also be just glued to the underside of the base 14. When the magnetically attracted tip 18 of the pen 12 is touched to the central disk magnet 20, the pen 12 can be let go and it will remain balanced above the base 14, either straight up, or tilted as shown and generally preferred. To achieve tilt as opposed to straight vertical, the pen can be made heavier, or the strength grade of either the annular magnet 16 or ring magnet 22 reduced. The annular magnet 16 can be a stack of disk magnets, and reducing the height of the stack is one way to reduce the strength. The grades of the magnets are typically in the range of N38 to N50 (millions of Gauss Oersted).

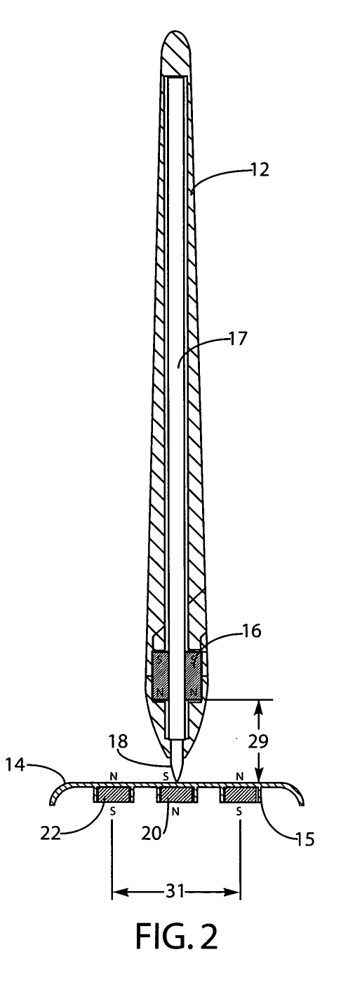

FIG. 2 provides a cross sectional elevation view of the straight-up pen version of the present invention. Housed within a pen barrel 12 is the elongated ink cartridge 17 ending at tip 18 and surrounded by an annular magnet 16 adjacent the writing tip 18 about a distance 29 from the tip. In normal resting position, the pen tip 18 resides touching or in close proximity to the central disk magnet 20. The pen tip 18 must be magnetically attractive, either a ferrous metal or something magnetized. A ring or donut-shaped magnet 22 resides in the same plane and has a center diameter of 31. The magnets 20 and 22 are glued to the underside of a base 14 with underside structure 15 helping to keep them in position. Typical dimensions for the disk magnet 20 are a diameter and a thickness of 3 to 5 millimeters (mm). The ring magnet 22 will usually have a thickness of 3 to 5 mm and an inside diameter of about 15 to 40 mm. The annular magnet 16 is typically about 10 mm outside diameter and the distance 29 will be at least 16 mm from the tip 18. The polarity of the lower end of the annular magnet 16 must be the same as that of the top face of the ring magnet 22. The ratio of mean diameter 31 to mean elevation 29 should be about 1.2 to 2.0.

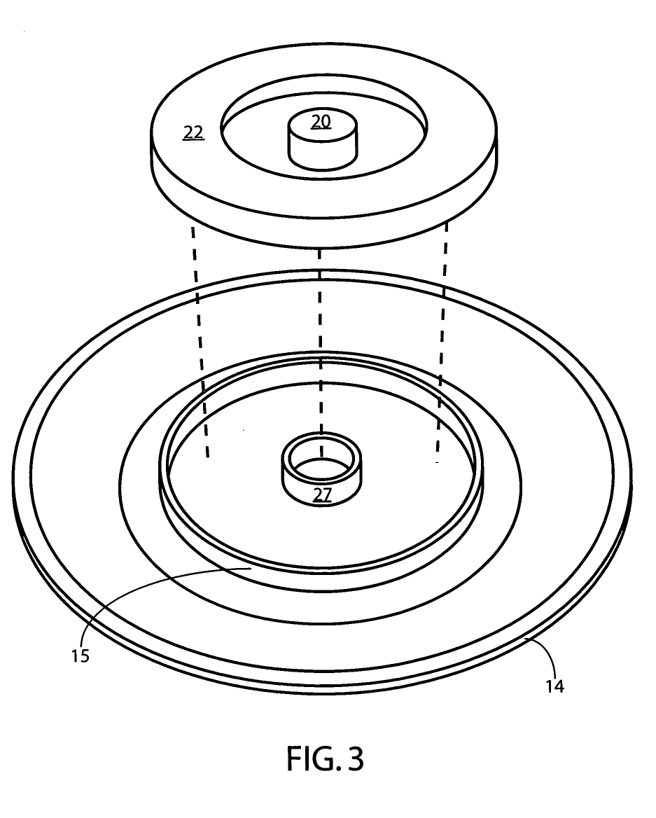

An exploded perspective view of the underside of an alternative base construction is provided in FIG. 3. The base 14 is typically smooth on the topside which faces up in normal use. The central disk magnet 20 fits into and is glued into a recess 27 molded into the base 14. The ring magnet 22 fits inside base ring 15 and is glued to the base 14. While the polarity of the disk magnet 20 is not critical, that of the ring magnet 22 touching the base must be the same as that of the closer end of the annular magnet in the accompanying balanced member. It is preferable that the polarity of the upper surface of the disk magnet 20 be opposite that of the lower end of the annular magnet 16.

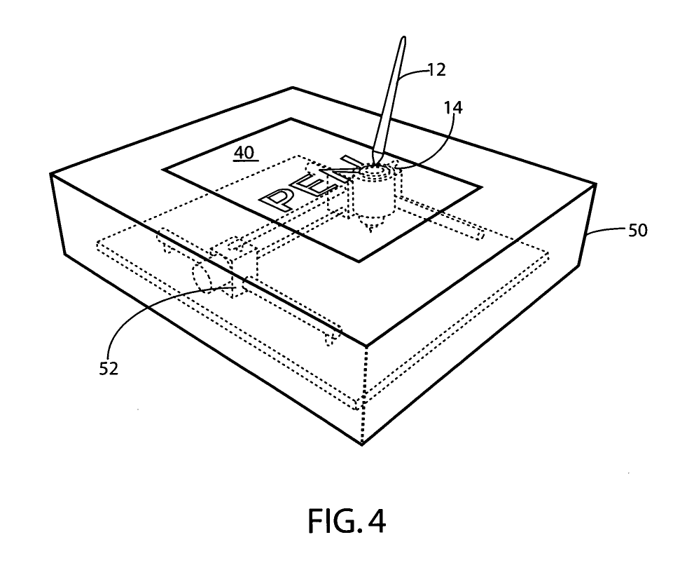

FIG. 4 is a perspective view illustrating a unique application of the present invention. A housing 50 contains within a computer operated mechanism 52 which holds the magnet base 14 with the magnets in a movable receptacle underneath the non-magnetic top surface of the housing 50. A piece of paper 40 is placed on the top surface of the housing 50 and above the magnet base 14. The special magnetic pen 12 is positioned above the paper 40 and base 14 such that it is self balancing in an upright or slanted position. A computer controls the movement of the receptacle holding the base such that words can be written on the paper 40 without anything contacting the barrel of the pen 12.

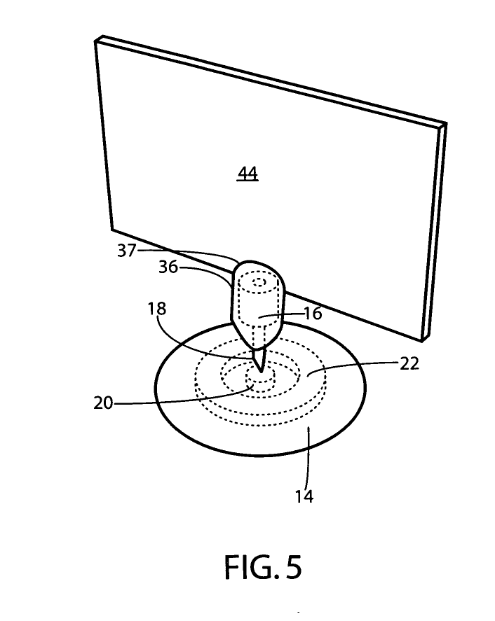

FIG. 5 provides a perspective elevation view of a business card holder that represents an alternative embodiment of the present invention. A base 14 holds a central disk magnet 20 and a ring magnet 22. A slotted housing 36 holds business cards 44 in a removable fashion. Within the housing 36, a cylindrical or annular magnet 16 is embedded. A magnetically attractable tip 18 extends axially down from housing 36. The polarity of the cylindrical magnet 16 at the surface closer to the base 14 needs to be the same as that of the top surface of ring magnet 22. In use, the housing 36 and cards 44 are removably retained in a tapered slot 37 and can be readily released from and returned to the holder 36. In addition, the holder member 36 can be readily removed from and returned to the base 14.

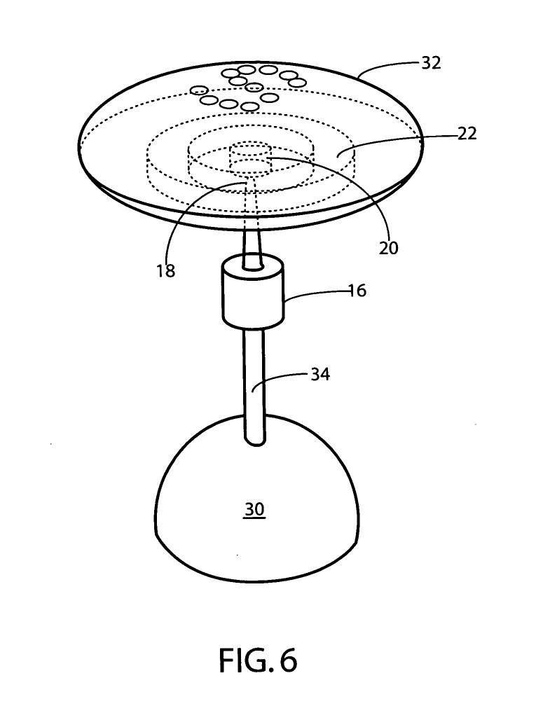

FIG. 6 provides an elevation perspective view of another alternative embodiment of the present invention. A base 30 holds a vertical rod 34 with an annular magnet 16 attached to the shaft at a fixed distance from the point 18 of the rod 34. A removable seasoning shaker 32 has two magnets imbedded in the underside opposite the shaker holes. There is a central disk magnet 20 and a ring magnet 22. The polarity of the downward-facing surface of ring magnet 22 is to be the same as that of the upward facing surface of annular magnet 16. In use, the shaker 32 with the embedded magnets 20 and 22 is readily removed off the tip 18 for dispensing the seasoning. After use, the bottom center magnet 20 is positioned above the tip 18 and released. The shaker 32 will remain balanced on the tip.

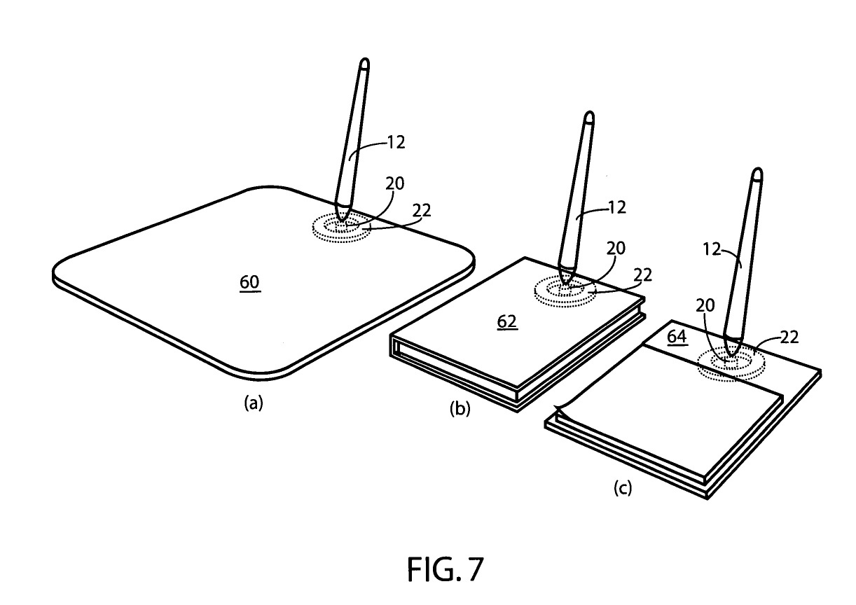

FIGS. 7(a), (b), and (c) depict alternative embodiments of the present invention wherein the magnets 20 and 22 are embedded invisibly within a common desk item instead of in their own base. They thus removably support the special magnetic pen 12 which will appear to magically stand upright on its own, either straight up or slanted. FIG. 7(a) depicts a mouse pad 60, FIG. 7(b) illustrates a book 62, and FIG. 7(c) presents a notepad.

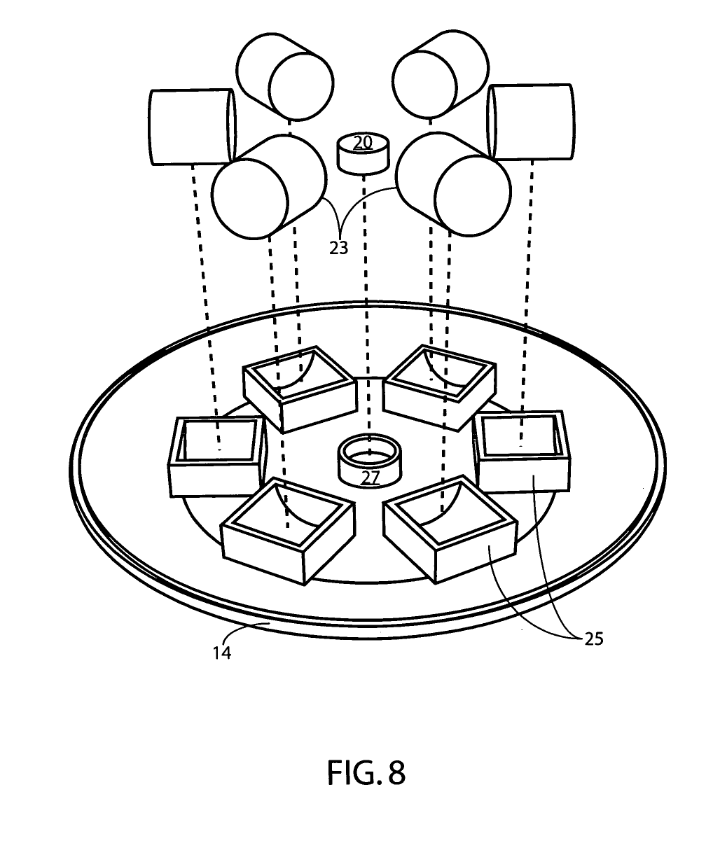

FIG. 8 provides an exploded bottom perspective view of an alternative arrangement of the magnets in the base 14. As above, there is a central disk magnet 20 with a top-side polarity opposite that of the lower end of the annular magnet in the accompanying pen, not shown. A multitude of individual magnets 23 are arranged in a circular pattern concentric with the disk magnet 20 with a separation between about ten and sixty millimeters. The individual magnets 23 can be small cylinders with their axes aimed at the central disk magnet 20, which is held in place by a short circular wall member 27. The polarity of the inward facing surfaces of magnets 23 must the same as that lower end of the annular magnet in an accompanying member. Also molded into or glued to the base 14 are magnet retention members 25 that hold the individual magnets 23 in place.

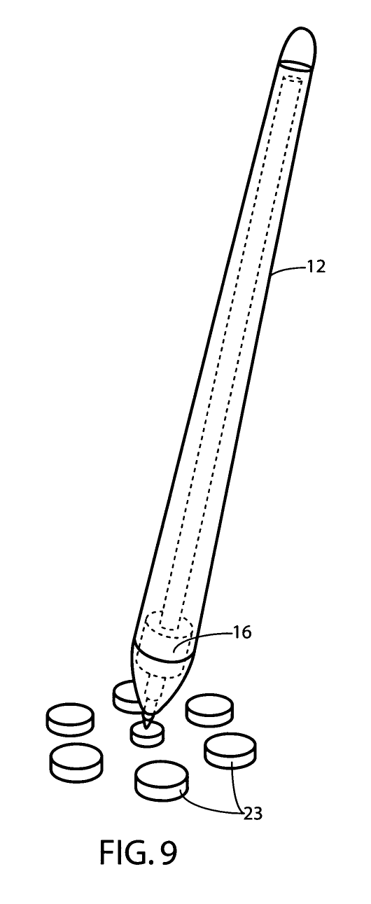

Alternatively, as shown in perspective in FIG. 9, the individual magnets 23 can be small disk or short cylinder magnets with a top-side polarity the same as that of the lower end of the annular magnet 16 in the accompanying pen 12. Small bar magnets could also be utilized. This arrangement of multiple magnets in a circle could be substituted for the ring magnet 22 shown in the units of FIG. 7, and may be encased in any such units. All the magnets are preferably neodymium type in a specific strength range typically classified as N38 to N50, and can be plated, coated, or encased in plastic or rubber.

While a presently preferred and various alternative embodiments of the present invention have been described in sufficient detail above to enable a person skilled in the relevant art to make and use the same, it should be obvious that various other adaptations and modifications can be envisioned by those persons skilled in such art without departing from either the spirit of the invention or the scope of the appended claims.

What is claimed is:

1. A magnetically self-balancing pen and base comprising:
a) a base member having at least one substantially flat-resting side;
b) a disk magnet at a predetermined position within said base member;
c) a preselected ring magnet having a predetermined inside diameter disposed within said base member concentric with said disk magnet; and
d) a pen assembly having a barrel, an elongated ink cartridge with a magnetically attractable tip, and at least one annular magnet disposed within said barrel and surrounding a portion of said elongated ink cartridge, said annular magnet positioned a predetermined distance from said magnetically attractable tip with an end proximal said tip having a polarity equal to that of an upper surface of said ring magnet.

2. The magnetically self balancing pen and base, according to claim 1, wherein said predetermined inside diameter is about 15 to 50 millimeters.

3. The magnetically self balancing pen and base, according to claim 1, wherein said predetermined distance from said magnetically attractable tip is about 10 to 50 millimeters.

4. The magnetically self balancing pen and base, according to claim 1, wherein said base member is one of a mousepad, book, and notepad.

5. The magnetically self balancing pen and base, according to claim 1, wherein said preselected ring magnet is a solid ring of neodymium type of strength grade between N38 and N50.

6. The magnetically self balancing pen and base, according to claim 1, wherein said at least one annular magnet is a neodymium type with a combined strength equivalence in a range of N38 to N50.

7. A magnetically self-balancing object and holder comprising:
a) a base member housing a disk magnet and a concentric ring magnet having a predetermined inside diameter;
b) a holder member having a magnetically attractable pointed proximal end and a distal end;
c) at least one cylindrical magnet disposed within said holder member with a predetermined distance between said pointed proximal end and a proximal end of said at least one cylindrical magnet; and
d) an item holding means disposed at said distal end of said holder member for removably holding at least one preselected desk item.

8. The magnetically self balancing object and holder, according to claim 7, wherein said predetermined inside diameter is about 15 to 50 millimeters.

9. The magnetically self balancing object and holder, according to claim 7, wherein said predetermined distance from said magnetically attractable tip is about 10 to 50 millimeters.

10. The magnetically self balancing object and holder, according to claim 7, wherein said item holding means is a tapered slot in said distal end of said holder member.

11. A magnetically self-balancing object and base comprising:
a) a base member having at least one substantially flat-resting side;
b) an elongated rod member fixedly attached to and rising substantially vertically from said base member, said elongated rod member having a magnetically attractable tip at a distal end;
c) a removable balancing object having at least an upper and lower surface;
d) a preselected disk magnet centrally located adjacent said lower surface of said balancing object;
e) a preselected ring magnet having a predetermined inside diameter disposed adjacent said lower surface of said balancing object within said balancing object concentric with said disk magnet; and
f) an annular magnet surrounding a portion of said elongated rod member, said annular magnet positioned a predetermined distance from said magnetically attractable tip with an end proximal said tip having a polarity equal to that of a lower surface of said magnetic ring.

12. The magnetically self balancing object and base, according to claim 11, wherein said predetermined inside diameter is about 15 to 50 millimeters.

13. The magnetically self balancing object and base, according to claim 11, wherein said predetermined distance from said magnetically attractable tip is about 10 to 50 millimeters.

14. The magnetically self balancing object and base, according to claim 11, wherein said preselected ring magnet is a solid ring of neodymium type of strength grade between N38 and N50.

15. A magnetically self-balancing pen and base comprising:
a) a base member having at least one substantially flat-resting side;
b) a disk magnet at a predetermined position within said base member;
c) a plurality of individual magnets arranged in a predetermined pattern with centers of said individual magnets all a predetermined substantially equal distance from said disk magnet; and
d) a pen assembly having a barrel, an elongated ink cartridge with a magnetically attractable tip, and at least one annular magnet disposed within said barrel and surrounding a portion of said elongated ink cartridge, said annular magnet positioned a predetermined distance from said magnetically attractable tip with an end proximal said tip having a polarity equal to that of proximal ends of said individual magnets.

16. The magnetically self balancing pen and base, according to claim 15, wherein said predetermined distance from said magnetically attractable tip is about 10 to 50 millimeters.

17. The magnetically self balancing pen and base, according to claim 15, wherein said predetermined substantially equal distance is about 15 to 50 millimeters.

18. The magnetically self balancing pen and base, according to claim 15, wherein said predetermined pattern is a circle concentric with said disk magnet.

19. The magnetically self balancing pen and base, according to claim 15, wherein said base member is one of a mousepad, book, and notepad.

20. The magnetically self balancing pen and base, according to claim 15, wherein said at least one annular magnet is a neodymium type with a combined strength equivalence in a range of N38 to N50.
